(19) United States
(12) Patent Application Publication
(10) Pub. No.: US 2019/0069090 A1
(43) Pub. Date: Feb. 28, 2019

(54) Novel Method for Delivering Stereo Modulations in a Motor Vehicle

(71) Applicant: Claude Carpentier, Maisons Laffitte (FR)

(72) Inventor: Claude Carpentier, Maisons Laffitte (FR)

(21) Appl. No.: 15/768,983

(22) PCT Filed: Oct. 17, 2016
(86) PCT No.: PCT/FR2016/000170

§ 371 Date: Apr. 17, 2018

(30) Foreign Application Priority Data
Oct. 20, 2015 (FR) 15/02210

(51) Int. Cl. H04R 5/04; H04R 5/02; H04R 1/26; H04S 7/00

(52) U.S. Cl. CPC H04R 5/04; H04R 5/02; H04R 2430/03; H04S 7/30; H04R 2499/13; H04R 1/26

(57) ABSTRACT

The method of the invention is based on a complete redesign of the position of loud-speakers in a motor vehicle. The basic configuration comprises two loud-speakers located under the front seats, a central loud-speaker for the rear passengers, and a woofer located outside the main passenger compartment.

New method of reproduction of stereophonic modulations in automobile.

All cars manufactured by automakers are equipped with a sound reproduction system to reproduce stereophonic modulations.

The stereophonic process makes it possible to obtain a continuous and homogeneous sound image from two point sources provided that the listener is located equidistant from these two sources.

Since it is impossible for two listeners sitting side by side in a car to be equidistant from two speakers playing the left and right channels, the conventional stereophonic process does not work properly in cars.

We will first clarify the meaning of some technical terms used below.

In stereophonic reproduction, we call the sound stage the set of points in the space from which the sound modulation seems to come from. The sound stage must be as wide and as deep as possible.

Sound image is the positioning of sound objects within the sound stage. The sound image must be reproduced in a consistent manner in positioning, level and timbre. The center of the sound image must correspond to the center of the sound stage and in the car it must be located in a position close to the longitudinal plane of symmetry of the car.

The stereophonic sound image is generated by frequencies above about 150 Hz. The frequencies below are the low frequencies.

In stereophonic reproduction there are 3 main modes, namely:
the uncorrelated isobar mode in which the electrical signals of the two channels have the same level but their phase is not correlated, for example a stereophonic modulation generating a chorus uniformly distributed over the entire sound stage is in uncorrelated isobar mode.
The correlated isobar mode in which the levels of the electrical signals of the two channels are equal and the left and right signals are in phase for example a stereophonic modulation generating one singer in the middle of the sound stage is in correlated isobar mode
The unbalanced mode, in which the level of a channel is zero, for example a modulation generating an instrument alone at one end of the sound stage is in unbalanced mode.

These three main stereophonic modes are identifiable using the level (n) and phase (c) correlation indices between the channels.

These indices each take, at each moment, a value between 0 and 1.

n=1 when the channel levels are equal and n=0 when the level of a channel is zero.

c=1 when the two channels are in phase and c=0 when the phase of the two channels is not correlated.
For uncorrelated isobar mode n=1 and c=0.
For correlated isobar mode n=1 and c=1.
For unbalanced mode n=0 and c not defined

In uncorrelated isobar mode the sound stage must be as wide as possible and both listeners must perceive both ends of the sound stage with the same intensity, so the configuration is called “double isobar”.

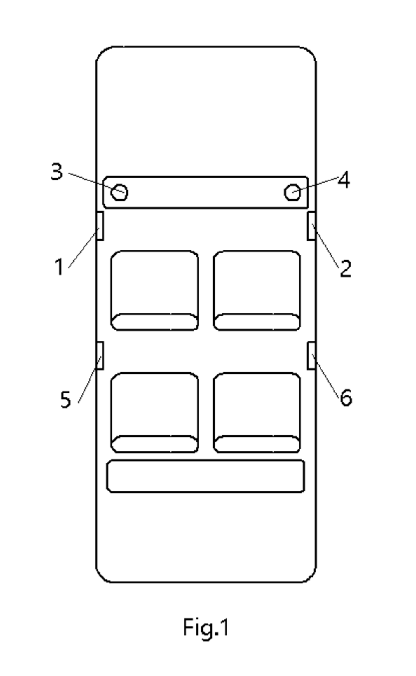

FIG. 1 shows schematically the traditional configuration currently adopted by automakers.

Speakers 1 and 2 are installed in the front doors that reproduce the low and mid frequencies, tweeters 3 and 4 are installed at the ends of the dashboard that reproduce the high frequencies and full-band speakers 5 and 6 are installed in the rear doors.

This configuration produce poor results.
At the front and rear of the car, there is predominance of the sound level at the end of the sound stage closest to the listener and the center of the sound image is poorly positioned and poorly correlated.

The low frequencies are poorly distributed and especially around 75 Hz there is a deficit in the front of the car and a significant overpressure at the rear.

In some cars, a center channel is added in the middle of the dashboard, which improves the reproduction of the center of the sound image at the front of the car but does not compensate for the level deficit at the end of the sound stage the farthest from the listener.

According to French Patent No. 2808407, we have proposed a new method of reproducing stereophonic modulations in cars consisting of installing loudspeakers under the front seats. Compared to the traditional configuration, this configuration is less expensive and gives to the front of the car a much better reproduction of the stereophonic image. But at the back, the sound lacks level and low frequencies below 50 Hz are missing at the front and the rear of the car.

According to French Patent No. 2975857, we have improved the process described above by providing in particular an additional bass speaker diffusing the frequencies below 50 Hz. In the method according to the present invention we have extended the bandwidth of this speaker up to 100 Hz with several benefits that we will describe.

According to French Patent No. 2985143, we have proposed an improvement of the reproduction of the stereophonic image at the front of the car, but the reproduction at the rear remains insufficient, as well as the reproduction of the low frequencies.

The present invention is a new method for reproduce stereophonic modulations in cars, generating a good reproduction of the stereophonic modulations at the front and rear of the car and a reproduction of the low frequencies well improved compared to known configurations.

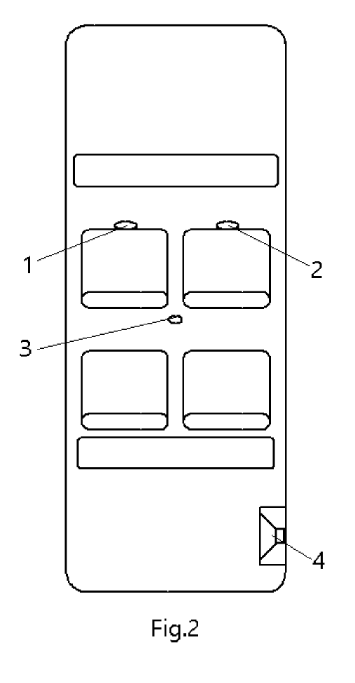

The FIG. 2 diagrammatically represents the basic configuration of the method for reproduce stereophonic modulations in automobiles according to the present invention.

Speakers 1 and 2 are installed under the front listeners. Compared to the doors before this position to several advantages
a significantly improved sound image width
a center of sound image well positioned and quite well correlated
better performance in low frequencies above 50 Hz

Thus, with loudspeakers of 10 cm in diameter, the same level is obtained above 50 Hz as with 16 cm loudspeakers in the doors. For low-end vehicles wide bandwidth speakers are enough. For high-end vehicles we can add tweeters.

At the rear of the car behind the front passengers and in front of the rear passengers, and in the longitudinal plane of symmetry of the car is installed a speaker 3 reproducing the sum of the two channels. It may be a 8 cm in diameter speaker with a approximately vertical axis.

For low-end cars a full-band speaker is enough. For high-end cars we can add a tweeter.

When we adjust the level of this speaker so that it is perceived at the rear of the car at the same level as the front speakers, you get at the back of the car a sound image well distributed with the center of the sound image well positioned. This configuration is much nicer to listen than the traditional configuration with the speakers in the doors.

A speaker 4 reproducing the low frequencies up to about 100 Hz is installed outside the passengers compartment so that the mid frequencies are filtered acoustically by the walls of the passengers compartment.

In this way we can make work this speaker to a much higher level because the acoustic distortions are not perceived by the listeners, which would not be the case if it was installed in the passenger compartment.

The trunk is usually a good location for this speaker.

The set of front 10 cm loudspeakers and a 18 cm bass speaker create a low frequency level equivalent to the 4×16 cm of the traditional configurations.

The configuration according to the present invention comprises 4 loudspeakers instead of 6 and a total of 250 cm² membrane surface instead of 450 cm² of traditional configurations and a reduction of 45% surface area with the cost and weight reductions induced.

This configuration has a ratio quality of reproduction/cost, excellent but the result is not perfect, and it differs quite significantly from one vehicle to another.

In some cars the sound level is too low at the end of the sound stage closest to the listener.

This too low level can be fairly well compensated by adding tweeters to the ends of the dashboard. And, we can lower the cutoff frequency of the high-pass filters of these tweeters low enough which increases the level perceived without for this too degrade the position and the correlation of the center of the sound image. 500 Hz is the extreme low limit not to be exceeded and 1000 Hz is a good average value.

In some cars the reproduction of the center of the sound image is too low. This can be compensated by adding a speaker in the center of the dashboard reproducing the sum of the two channels.

When you have a center speaker, and you add full-band speakers at the ends of the dashboard, by adjusting their level appropriately compared to that of the speakers below the front seats we get a double-isobar configuration in isobar uncorrelated mode with a center of sound image located in front of each listener which is a result quite defensible.

With the addition of an electronic control we can be obtained from this last speakers configuration, hitherto unknown rendering quality in a car, namely a perfect result for the three main stereo modes.

In the following we will call interior speakers the speakers located under the front seats and end speakers the speakers located at the ends of the dashboard. Each of these four speakers and the center channel reproduce all the medium and treble frequencies.

In conventional two-source stereo, when the listener is equidistant from the speakers reproducing the left and right channels, the stereophonic process perfectly reproduces each of the three main stereo modes.

But, with our five speakers configuration, if you want to get the center of the sound image in the middle of the dashboard, you get a level too high in the center of the sound stage in uncorrelated isobar mode. In addition, in correlated isobar mode the end speakers degrade the reproduction of the center, and in unbalanced mode the center channel and the interior speakers reduce the width of the sound image.

In order to obtain the best possible result for each main stereophonic mode we have defined for each of them the configuration of loudspeakers generating the best result and we enslaved the level of all the speakers for the frequencies located above 150 Hz to the indices (n) and/or (c) so that for each main stereophonic mode, only the loudspeakers selected to reproduce this mode are perceived.

According to the present invention, the uncorrelated isobar mode is reproduced mainly by the interior loudspeakers and the end loudspeakers, the central channel not being perceptible; the correlated isobar mode is reproduced by the interior speakers and the center channel, the end speakers are not perceptible and the unbalanced mode is reproduced by the end speakers alone, the interior speakers and the central speaker not being perceptible.

In the following:

α is the reduction coefficient of the central channel level for the uncorrelated and unbalanced isobar modes.

β is the reduction coefficient of the level of the interior speakers in unbalanced mode.

γ is the reduction coefficient level of the end speakers in correlated isobar mode.

δ is the coefficient of increase of the level of the end loudspeakers in unbalanced mode to maintain intact the general level.

The level of the central channel can be multiplied by [(1−α)×(c×n)+α] which is equal to α in uncorrelated isobar mode, 1 in correlated isobar mode and α in unbalanced mode.

The level of the indoor speakers can be multiplied by [(1−β)×(n)+β] which is equal to 1 in correlated and uncorrelated isobar modes and β in unbalanced mode.

The level of the end speakers can be multiplied by [1+δ×(1−n)]×[(1−γ)×(1−c×n)+γ] that is equal to 1 in uncorrelated isobar mode, γ in correlated isobar mode and δ in unbalanced mode.

In an analog device, the level variation can be achieved by using gain controlled amplifiers THAT 2181 whose gain is controlled by a voltage that can be generated by an assembly of ANALOG DEVICE AD633 multiplier circuits.

When the control voltage is zero the gain of the circuits THAT 2181 is equal to 1. When the control voltage is negative the gain increases by one decibel per increment of 0.0061 volts, and when the control voltage is positive the gain decreases in same proportions.

If (α) is the decibel reduction adopted for the central channel, (β) the decibel reduction adopted for the interior speakers and (γ) the reduction in decibels adopted for the end speakers in correlated isobar mode and (δ) the increase in decibels of the level of the end speakers in unbalanced mode.

The control voltage of the central channel may be equal to [(0.0061×α)×(1−c×n)]

The control voltage of the interior speakers may be equal to [(0.0061×β)×(1−n)]

The control voltage of the end speakers may be equal to [(0.0061×γ)×(c×n)−(0.0061×δ)×(1−n)]

Whether in digital or analog, we get in this way, in the front of the car, an excellent result in all stereophonic modes.

When the budget allows, an improvement of listening to the rear seats is to add a speaker behind back seats and in the longitudinal axis of symmetry of the car, for example on the back shelf reproducing the signal of difference between both channels.

The addition of this speaker provides a very pleasant feeling on large orchestral masses retaining a predominance of the front especially for the voices in the center of the sound image because the difference signal excludes the isobar correlated mode.

Regardless of the configuration selected for the reproduction of the sound image at the front of the car, the reproduction of the low frequencies is the same. They are produced on the one hand by the interior speakers that reproduce low frequencies between about 50 Hz and 150 Hz and by a bass speaker that reproduces the low frequencies below about 100 Hz. In most cars, there is a slight deficit in the 75 Hz band at the front and a significant overpressure at the rear of the car.

According to the present invention these defects can be eliminated in the following way:

First of all we make equal the levels produced in this frequency band at the back of the car on the one hand by the bass speaker and on the other hand by the speakers under the front seats.

In a second step, a phase shift is applied between the interior speakers and the bass speakers so as to bring them substantially in phase opposition to the rear of the car in this frequency band.

The relative phase can be adjusted by adjusting the phase of the high-pass filters of the interior speakers and low-pass filter of the bass speaker

Our tests showed that this adjustment led to the fact that in this frequency band the waves produced by the interiors speakers and the one produced by the bass speaker are substantially in phase at the front of the car, which increase the level which was too low in this frequency band.

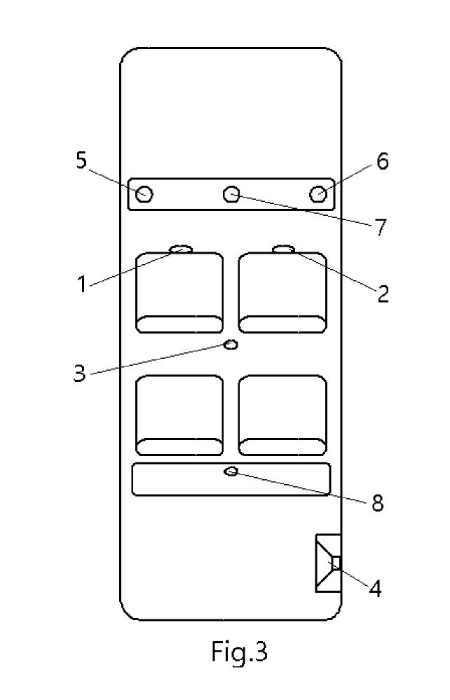

FIG. 3 schematically illustrates the position of the loudspeakers of the configuration according to the most sophisticated present invention. Compared to the basic configuration, speakers 5 and 6 were added to the ends of the dashboard, a center speaker 7 was added in the middle of the dashboard and a speaker 8 has been added in the center of the back beach.

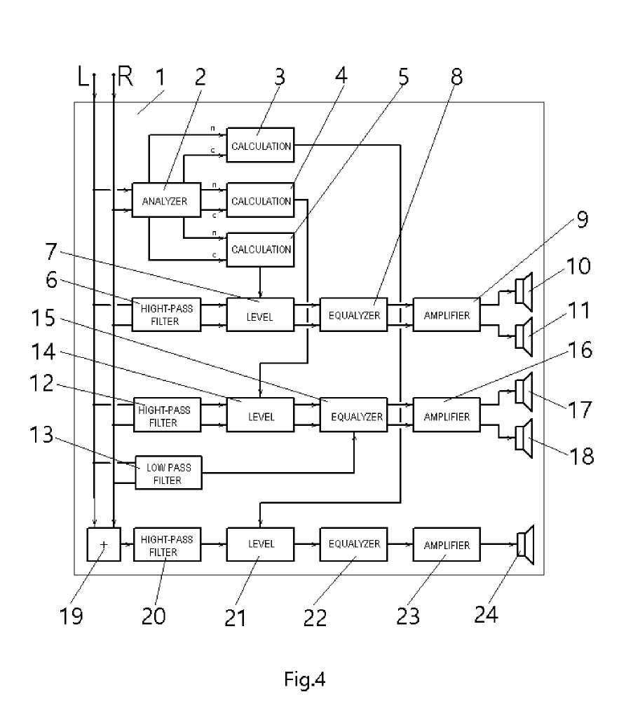

FIG. 4 illustrates the general diagram of a device 1 for implementing the method of controlling the level of the front loudspeakers according to the most efficient variant of the present invention. In this exemplary embodiment, the end loudspeakers and the center channel are high-pass filtered at 150 Hz and the modulation fed to the interior loudspeakers is divided into a high-pass portion whose gain is controlled and a low-pass portion whose gain remains constant, in order to obtain a constant reproduction of the low frequencies.

The input channels L and R come from a source of stereophonic modulations.

An analyzer 2 compares L and R and derives at each instant an averaged value for (n) and an averaged value for (c). (c) and (n) are introduced in three calculation stages 3, 4 and 5 at the output of which we obtain either the numerical multiplying coefficients or the analog control voltages of the level-matching stages.

L and R feed a two-channel high-pass filter 6 followed by a two-channel level adapter stage 7 and then a two-channel equalizer stage 8 and then a two-channel power amplifier 9 which supplies the end speakers 10 and 11.

L and R feed a two-channel high-pass filter 12 and an adder low-pass filter 13. The high-pass filter is followed by a two-channel level adapter stage 14. The outputs of the level adapter 14 and low-pass filter 13 are added to the input of the two-channel equalizer 15 which is followed by a two-channel power amplifier 16 which supplies the interior speakers 17 and 18.

L and R feed a summing circuit 19 followed by a high-pass filter 20 and then a level-matching stage 21 followed by an equalizer stage 22 and then a power amplifier 23 which supplies the central speaker 24.

This process may be the subject of an electro-acoustic device for equipping motor vehicles.

1. A method for reproducing stereophonic modulations in cars, characterized in that the stereophonic sound images at the front of the car are mainly generated by loudspeakers located under the front passengers and the stereophonic sound images at the rear of the car are mainly produced by the addition of the acoustic waves emitted by the loudspeakers located at the front of the car and a loudspeaker installed in the longitudinal plane of symmetry of the car behind the front passengers and in front of the rear passengers and reproducing the sum of the two stereophonic channels.

2. A method according to claim 1 and characterized in that it is added two speakers located at the ends of the dashboard.

3. A method according to claim 2 and characterized in that the modulations feeding these added speakers are filtered high-pass at a frequency greater than 500 Hz.

4. A method according to claim 1 and characterized in that it is added a central speaker in the middle of the dashboard.

5. A method according to claim 1 and characterized in that the speakers added to the ends of the dashboard are full-band speakers and their level is adjusted relative to that of the speakers located under the listeners to get with these a double isobar configuration.

6. A method according to claim 1 and characterized in that the levels of these five loudspeakers for the frequencies of the medium and treble registers are slaved to level and phase correlation indices between the left and right channels in a way:
the uncorrelated isobar mode is reproduced by the assembly formed by the interior and end loudspeakers, the level of the central channel being sufficiently reduced so that it is not perceived.
the correlated isobar mode is reproduced by the set formed by the center speaker and the interior speakers, the level of the end speakers being sufficiently reduced so that they are not perceived.
the unbalanced mode is reproduced by the only end speakers, the levels of the center speaker and the interior speakers being reduced enough so that they are not perceived, the level of the end speakers is slightly raised to keep the overall level intact.

7. A method of reproducing stereophonic modulations in cars according to claim 1 and characterized by the fact that we adds in the longitudinal plane of symmetry of the car a speaker located behind the rear passengers and diffusing the difference signal between the two channels.

8. A method of reproducing stereophonic modulations in cars according to claim 1 and characterized in that the low frequencies are reproduced on the one hand by the speakers below the front passengers whose bandwidth is extended to down to around 50 Hz and on the other hand by a loudspeaker located outside the passenger compartment reproducing the frequency band below about 100 Hz and that their relative level in the 75 Hz band is adjusted to obtain the same acoustic pressure at the front and the rear seats of the car and that their relative phase in this frequency band is adjusted so that their acoustic waves are in phase opposition at the rear of the car.

9. An apparatus for reproducing stereophonic modulations in cars for carrying out the method according to claim 1 comprising an electronic control unit as well as power amplifiers and several loudspeakers.

10. An automotive vehicle equipped with a stereophonic modulation reproduction device according to claim 9.
